(19) United States
(12) Patent Application Publication
(10) Pub. No.: US 2005/0213789 A1
(43) Pub. Date: Sep. 29, 2005

(54) Component arranged directly on a t-coil

(75) Inventors: Jan Frieding, Rapperswil (CH); Jurg Sudan, Zurich (CH)

Correspondence Address: PEARNE & GORDON LLP, 1801 EAST 9TH STREET, SUITE 1200, CLEVELAND, OH, 44114-3108, US

(73) Assignee: Phonak AG, Stafa (CH)

(21) Appl. No.: 10/810,945

(22) Filed: Mar. 26, 2004

(51) Int. Cl. H04R 1/00; H04R 9/06; H04R 11/02

(52) U.S. Cl. 381/400; 381/407; 381/402; 381/410

(57) ABSTRACT

At small electric devices, such as in particular medical devices, as e.g. hearing devices, very small electric coils (1) are used. Especially with hearing devices e.g. so-called t-coils are used. Those t-coils are considered and arranged at hearing devices as inductivities with parasitic effects. Due to the very limited space, it is proposed that at very small coils, which are used within the mentioned electric or electronic small devices, the connections of the coil (5, 7) are interlinked directly at the coil (1) over a component (9), an assembly group and/or a circuit. The connections of the coil (5, 7) are arranged on one or more screens or small panels which are firmly arranged on or at the coil comprising so-called pads (6, 8), which connections are interlinked with the use of a capacitor or condenser (9) and onto which pads external connections (11, 13) are directed for the external connecting of the coil.

The present invention refers to a coil assembly according to the introduction of claim 1, a process for the production as well as uses of the coil assembly.

At small electrical devices, such as in particular devices for medicine as e.g. hearing devices, very small electric coils are used. At hearing devices so-called t-coils or telephone coils e.g. are used. Such t-coils are considered and arranged at hearing devices as inductivities with parasitic effects. This physical coil therefore has a performance Q and a resonant frequency fres.

For the reception of remote control signals, one wants e.g. to lower resonant frequency of typically 150 kHz to the frequency of transmission. This usually happens when using one or more capacitors parallel to the coil.

In particular with the mentioned smallest devices, such as e.g. hearing devices, it is often impossible, due to the very small dimension of electronics or the dimension or number, respectively, of necessary capacitors, to arrange them within the electronic assembly group. The decade is not sufficient and a further external capacitor has to be used.

One subject of the present invention is to propose a possibility of how a further capacitor can be arranged at limited room conditions within small electrical devices.

In general, the subject lies in small electrical or electronical devices within electronics with at least one coil to increase the amount of internal components to be arranged in order to fulfil corresponding requirements to electronics.

According to the invention, the above mentioned problems are solved by using a coil assembly according to the wording of claim 1.

It is proposed to arrange directly on or at the coil a component or circuit at the connections of the coil to interlink those connections.

Preferably, the coil has solderable, radial connections which are thus set at a distance that arranging of the component or the circuit is possible.

According to a further design, the connections are arranged on at least one at or on the coil adapting or overlying print, such as e.g. a small plastic panel with two pads mounted on it, on which also the component or circuit may be arranged for interlinking the two connections.

The component or the assembly (surface mounted device) may be e.g. a capacitor which is arranged on the front side of a rod-like coil and is connected to the two connections which on their part are connected to connections from outside, such as e.g. cords or wires.

The coil, equipped as proposed according to the present invention, such as e.g. a so-called t-coil, does not have to be in any case a cylinder- or rod-like coil, but also the use of ring-shaped coils or different suitably designed coils is possible.

It is also possible that two or more cylinder-like or rod-like coils are used at whose connections e.g. a capacitor is arranged. It may also be about coils which are arranged at a transformer or which are arranged concentrically.

Further preferred versions of the designed coil assembly according to the present invention are characterised in the dependent claims.

Further proposed is a process for the production of a coil assembly according to the wording of claim 9. Accordingly, it is first proposed to direct the connections of the coil on to so-called connection pads to be fixed, such as e.g. by soldering, welding or be bonding, afterwards to arrange the component or the circuit with which the two connections of the coil are connected to each other and finally to connect the connections of the coil on the pads with connections supplied from the outside, such as e.g. cords or wires. The component, such as the capacitor, is soldered simultaneously on both sides while the cords or wires are connected individually to the connections on the pads. The coils assembly as proposed according to the present invention is in particular suitable for the use within a electronic of smallest medical devices, such as e.g. a hearing device.

The following description of an implementation example will explain this invention in more detail with reference to the attached drawings in which:

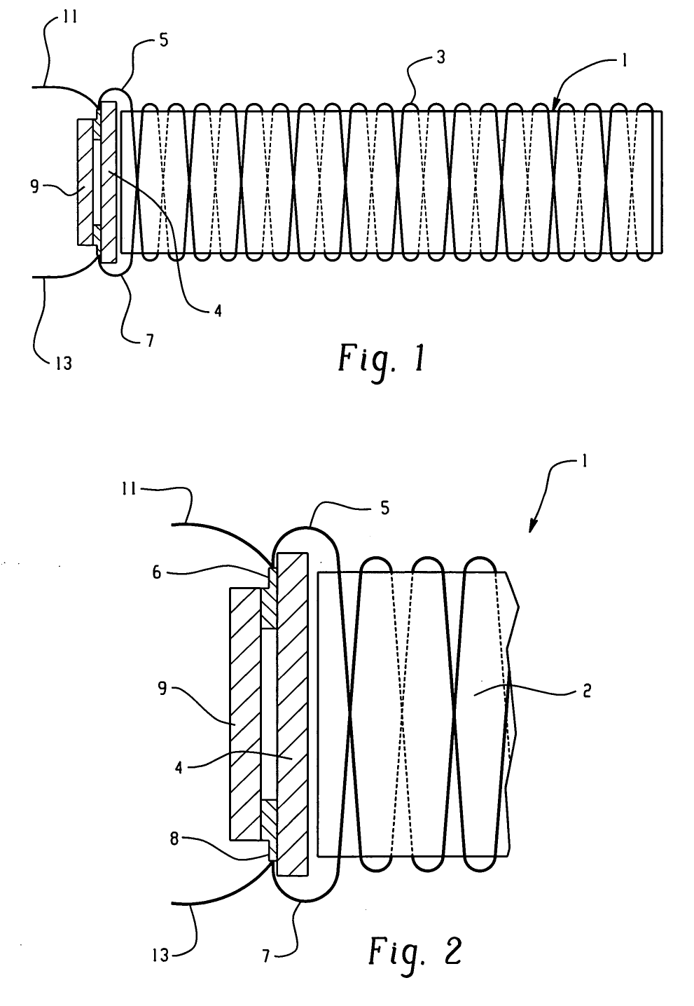

FIG. 1 is a schematic longitudinal view of a cylinder-like coil according to the present invention,

FIG. 2 is an cut-out of the coil of FIG. 1,

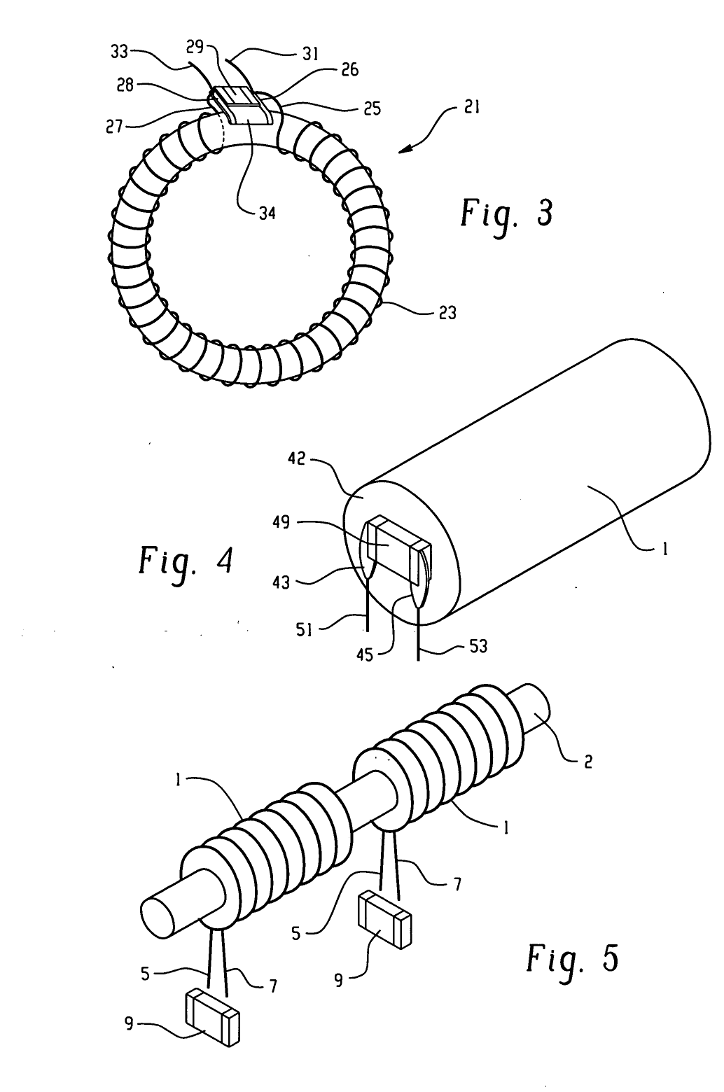

FIG. 3 a further design of a ring-shaped coil,

FIG. 4 a schematic illustration for the better understanding of the present invention,

FIG. 5 two coaxially arranged cylinder-like coils,

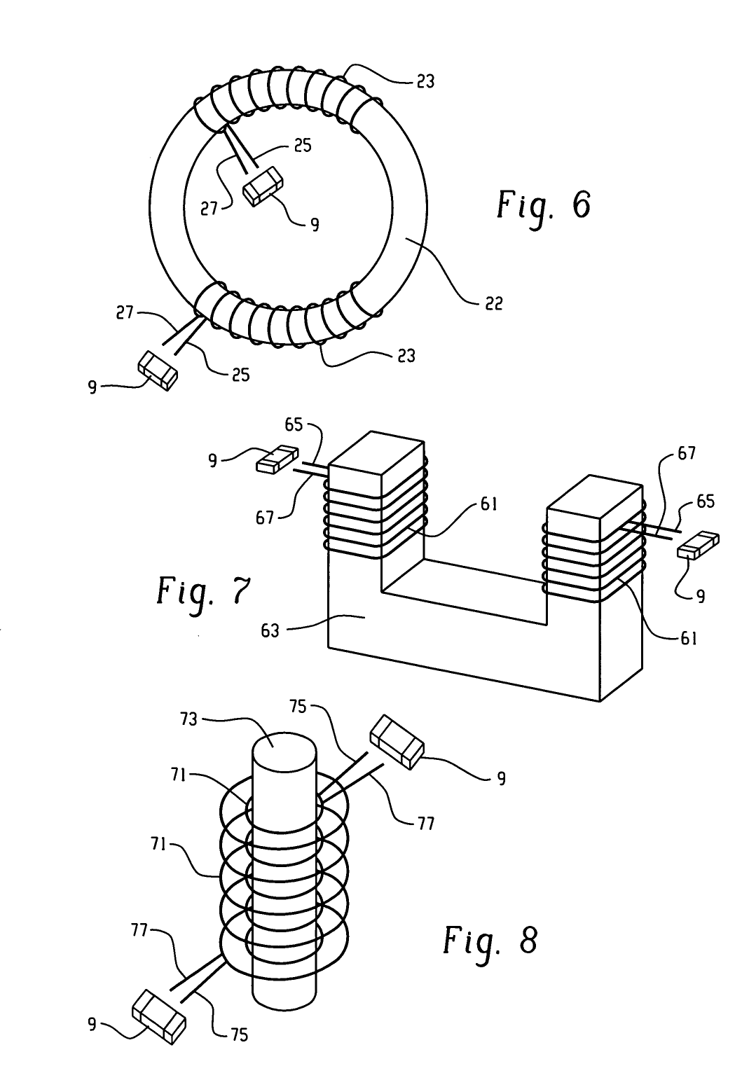

FIG. 6 shows two kotoridally arranged coils,

FIG. 7 shows two coils arranged at shanks of an anchor of the body of a current transformer and

FIG. 8 shows two concentrically arranged coils.

FIG. 1 shows in longitudinal view schematically a rod- or cylinder-like coil comprising a coil body 1 with windings 3 arranged on the coil body. Of course, the view is an x-times magnified enlargement but in fact the coils as proposed according to the present invention, usually are very small coils which have dimensions of e.g. maximal length of some millimetres. On the front side of the cylindrical-like coil are the two connections 5 and 7 of the coil, which are interlinked over a capacitor 9. At the same time the two connections 5 and 7 are connected to the connections 11 and 13 supplied from the outside.

In FIG. 2 the front side of the coil from FIG. 1 is shown in an enlarged view in which the two connections 5 and 7 are clearly visible, which are directed on two connecting pads 6 and 8, which pads are arranged on a small plate or panel 4. The connections are soldered on these preferably metal pads. Connecting the two connections 5 and 7 a capacitor 9 is arranged and additionally the two external connections 11 and 13 are directed onto the connecting pads 6 and 8.

Of course, the cylinder-like or rod-like coil according to FIGS. 1 and 2 is only an example and also the use of cylinder-like coil bodies is not obligatory. Especially at smallest coils, coil windings are very often used without a respective coil body.

In addition, it is e.g. also possible to use a ring-shaped coil or a so-called toroid coil, which is schematically shown in FIG. 3. The ring-shaped coil 21 has windings 23 which have at both ends the connections 25 and 27 which are again preferably soldered on metal pads 26 and 28 which pads are bonded on a plate or panel 31 which e.g. is made out of a polymer material. The connections 25 and 27 are again interlinked over e.g. a capacitor 29. In addition, the coil connections 25 and 27 are connected with connecting wires 31 and 33 which are supplied from the outside.

In FIG. 4 the inventive idea is illustrated according to a schematic illustration, as at the front side 42 of a coil 1, which can be e.g. a telephone coil or a so-called t-coil, the connection pads 43 and 45 are arranged onto which the connections of the coil windings are directed. The two connections are interlinked over a so-called SMD-capacitor (Surface Mounted Device Capacitor) 49. Lacings or wires 51 and 53 are directed from the outside onto the two connection pads 43 and 45. The capacitor as shown in FIGS. 1 to 4 is, as proposed according to the present invention, directly soldered onto the coil or t-coil due to limited space and due to the preferable packaging. Therefore, the t-coil must have the two mentioned solderable radial connections which of course have to be big enough and to be set at an appropriate distance so that the (SMD−) capacitor can be arranged. Due to manufacturing reasons and to simplify the mounting of the capacitor and the connection of the external connections, so-called connecting pads are arranged as proposed within FIGS. 1 to 4.

Of course, instead of the capacitor, as shown in FIGS. 1 to 4, any other components may be arranged between the two connections; even the arrangement of an additional circuit is possible. Of course, the arrangement of a component or circuit between the two connections of a smallest coil is not limited to hearing aids, but smallest coils, as described, can also be used within remote control units, medical devices, etc. Besides the receipt of inductive signals in the sense of a so-called telephone coil, such kind of coils can also be used to generate higher frequencies for the modulation of signals to generate smaller inductivities in hearing aids, etc. In addition, it is also possible to equip smallest remote controls for the control e.g. of medical devices, e.g. arranged within a wrist watch, a fingering, etc., with a coil assembly as defined within the present invention.

A further advantage of the coil assembly according to the present invention is e.g. that a plurality of various coils which have different self-resonances can be tuned with appropriate capacities onto always the same resonances and are used exchangeably at the same circuit.

Of course, a plurality of inductivities can also be used on the same coil body or coil bodies which are interlinked.

With reference to the FIGS. 5 to 8, examples are shown in which at least two inductivities are arranged on one coil body. FIG. 5 e.g. shows two coaxially arranged inductivities or coils 1 which are arranged coaxially on one coil body 2 and which have each two connections 5 and 7. These connections can be connected over a component, such as e.g. a capacitor, as shown earlier with reference to the FIGS. 1 to 4. To simplify the illustration a capacitor 9 is shown only in outlines, which in correspondence to the respective arrangements within FIGS. 2 and 3 is connected to the connections of the coil on the pads.

Analogically, FIG. 6 shows two kotoroidally arranged inductivities or coils 23 which are arranged on a ring-shaped coil body 22. Again, the two coils 23 each have connections 25 and 27, which are again interlinked over a component such as a circuit or a capacitor.

FIG. 7 shows two inductivities or coils 61 which are each arranged on a shank of a U-shaped anchor body 63. The coils 61 each have connections 65 and 67. Finally, FIG. 8 shows two coils or inductivities 71 which are arranged concentrically around a coil body 73, having each connection 75 and 77. Again, these connections may be interlinked by a capacitor or an electronic array.

With the use of FIGS. 5 to 8 it should be demonstrated that a plurality of inductivities or coils can be equipped according to the present invention with respective components or electronic arrays, whereby the invention of course is not limited to two coils or inductivities as the arrangement of three or more inductivities or coils is also possible.

1. Coil assembly for small electric or electronic devices such as in particular for the use in acoustic and/or medical areas, comprising at least one small coil characterised in that the connections of the coil (5, 7, 25, 27) are interlinked directly on the coil (1, 21) by a component (9, 29), an assembly group and/or a circuit.

2. Assembly according to claim 1, characterised in that the connections of the coil (5, 7, 25, 27), directly on or at the coil (1), are arranged on so-called connecting pads (6, 8) and interlinked by a component (9) and/or a circuit.

3. Assembly according to one of the claims 1 or 2, characterised in that the connections of the coil (5, 7, 25, 27) are arranged on one or more screens or small panels which are firmly arranged on or at the coil comprising so-called pads (6, 8), the connections are interlinked with the use of a capacitor or a condenser (9, 29) and onto which pads connections from the outside (11, 13, 31, 33) are directed for the connection of the coil to the exterior.

4. Assembly according to one of the claims 1 to 3, characterised in that directly on or at the coil (1, 21) in the area of the connections (5, 7, 25, 27) a screen or a small panel (4, 34) is arranged preferably consisting of a polymeric material onto which small panels, on the side turned away from the coil, so-called connecting pads (6, 8, 26, 28) in particular made out of a metallic material, such as an electrically well conductive metal, are arranged, the connections (5, 7, 25, 27) of the coil are directed onto these pads and soldered to the pads and are interlinked by the aid of a condenser or capacitor (9, 29) and onto which pads external connections (11, 13, 31, 33) are directed for connecting the coil to the exterior.

5. Assembly according to one of the claims 1 to 4, characterised in that the at least one small coil is a cylinder-like coil with connections arranged at a front side (42), which connections are connected with each other by a component such as a condenser or capacitor (9).

6. Assembly according to one of the claims 1 to 3, characterised in that the small coil is a ring-shaped coil or a so-called toroid coil, the two connections of the at least one coil (25) are arranged close to each other on the ring-shaped coil at a distance which is sufficient in order to interlink the two connections by arranging a component or a circuit or assembly group.

7. Assembly according to one of the claims 1 to 6, characterised in that the component arranged between the connections is a capacitor or condenser, suitable for lowering the frequency of the remote control signals received by the coil.

8. Assembly according to one of the claims 1 to 7, characterised in that on one coil body (2, 22, 63, 73) two or more coils (1, 21, 61, 71) are arranged, the coil connections of at least one coil (5, 7, 25, 27, 65, 67, 75, 77) are connected with each other directly on the coil by the use of a component, an assembly group and/or a circuit.

9. Method for the production of a coil assembly according to one of the claims 1 to 8, characterised in that first the connections of at least one small coil largely close to each other are directed onto so-called connecting pads, arranged on or at the coil, afterwards the two connections on the connection pads are interlinked, using one component or circuit, and finally connections supplied from the outside, such as cords or wires, are connected to the connections of the coils on the pads e.g. by soldering.

10. Use of the coil assembly according to one of the claims 1 to 8 for the reception of inductive signals or high-frequency signals in hearing aids or in devices for the transmission of telecommunication signals.

11. Use of the assembly according to one of the claims 1 to 8 such as remote control devices for the control of hearing aids or for devices in the medical field.
